(19) United States
(12) Patent Application Publication
(10) Pub. No.: US 2006/0162573 A1
(43) Pub. Date: Jul. 27, 2006

(54) Electric toaster

(76) Inventor: Chung Yin Yip, Clearwater Bay (HK)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/532,715

(22) PCT Filed: Oct. 29, 2003
(86) PCT No.: PCT/IB03/06297

§ 371 Date: Nov. 21, 2005

(30) Foreign Application Priority Data
Nov. 1, 2002 (GB) 0225409.2

(51) Int. Cl. A47J 37/08

(52) U.S. Cl. 99/389

(57) ABSTRACT

There is provided an electric toaster for use in the toasting of a food product. The toaster comprises a body and within the body, at least one cavity for receipt of said food product. There is associated with said at least one cavity, at least one toasting element for toasting the food product. The toaster also comprises an electrical power control system for controlling the power of said at least one toasting element. The electrical power control system incorporates at least two different power on settings and the at least one toasting element is switchable between the at least two different power on settings during a toasting operation.

The present invention relates to an electric toaster for domestic or commercial use. The toaster may in aspects, be configured as a toaster for bread or other bakery products or as a toaster oven.

Electric toasters are well-known commercial and domestic appliances and are found in many kitchens. Typically, such toasters comprise a housing with a cavity for receipt of food product to be toasted and one or more toasting elements that operate in response to input from an electronic control system. The sophistication of existing electronic control systems varies from those involving timing mechanisms of various sorts to those incorporating sensors for sensing the degree of browning of the toasted product.

Whilst the toasting process is on the face of it quite straightforward, it remains difficult in practice to design an energy efficient toaster that provides effective browning without burning and the required degree of moistness and/or crispiness of the toasted product. Users of conventional toasters are familiar with the difficulties. Toaster manufacturers are therefore continually striving to enhance performance and efficiency of electric toasters whilst accepting that such enhancements must be implementable on a reasonable cost basis as fits with a product that typically commands only a moderate unit price at retail.

The Applicants have now devised a method of toasting which is both energy efficient and enables fast and effective browning without burning. The method also in aspects, enables enhanced degree of control of the moisture content of the inner part of the toasted product. The toasting method involves repeated switching between high and low power modes over the course of a toasting operation and is implementable at reasonable manufacturing cost.

According to one aspect of the present invention there is provided an electric toaster for use in the toasting of a food product, said toaster comprising

a body;

within said body, at least one cavity for receipt of said food product;

associated with said at least one cavity, at least one toasting element for toasting the food product; and

an electrical power control system for controlling the power of said at least one toasting element,

wherein said electrical power control system incorporates at least two different power on settings and the at least one toasting element is switchable between said at least two different power on settings during a toasting operation.

The invention provides an electric toaster for use in the toasting of a food product. The toaster may be configured for domestic or commercial use and have any suitable form including the form of a bread or other bakery product toaster or the form of a toaster oven. The objective of the toasting operation is generally browning of the product without burning (i.e. without blackening). In aspects, the toasting operation may be arranged to control the moisture content of the toasted product. In different aspects, it may be arranged to leave the food product soft and/or moist inside (e.g. standard bread toast) or it may be arranged to dry out and/or crisp the inner part of the food product (e.g. French toast).

The food product in aspects, may be a bakery product such as a brown or white bread slice, a muffin or a crumpet. In other aspects, the food product may be any food product for which a toasting-style cooking operation is suitable including certain meat, fish, dairy, fruit and vegetable products.

The toaster comprises a body (or housing) and provided to the body, at least one cavity for receipt of food product.

The body may have any suitable form including forms that are designed to be accommodated on a work surface in a domestic or commercial kitchen area.

The at least one cavity may similarly have any suitable form. The cavity may in aspects, be an open cavity or in other aspects, it may be closed off with a lid or door.

In one preferred aspect, the toaster is configured as a bread toaster. The at least one cavity therefore takes the form of a slot that is sized and shaped to receive a slice of bread. Embodiments with multiple bread-receiving slots are envisaged including 1 slice/1 slot; 2 slice/2 slot; 2 slice/1 slot; 4 slice/2 slot; 4 slice/4 slot; 3 slice/3 slot; and 6 slice/6 slot variations.

At least one toasting element for toasting the food product is associated with the at least one cavity. The toasting element is generally an electrically powered heating element that may be heated to a sufficient temperature (usually to ‘red or glowing heat’) for it to be used in a toasting operation. In one aspect, the heating element is a glass tube heating element. Power is generally provided through plugging the toaster into the mains electricity supply.

Each cavity may be associated with its own heating element(s) but in variations one or more heating element(s) may be associated with plural cavities and vice versa as is required for effective toasting operations to be implemented.

The toaster is provided with an electrical power control system for controlling the electrical power provided to the at least one toasting element. The electrical power control system generally comprises electrical control circuitry (e.g. located on a printed circuit board) for controlling the supply of electrical power to the heating element(s).

The electrical power control system incorporates at least two different power on settings. That is to say, the at least one toasting element is powerable to at least two different power on settings. The term ‘power on’ is used to mean a state where power is supplied to the at least one toasting element and thus specifically excludes the ‘power off’ state where no power is supplied thereto.

The exact values of the different power settings may be selected to match the requirements of the particular toasting operation of interest, and in particular to achieve desired levels of crisping, browning and moisture content of the toasted product.

In one aspect herein, the different power on settings are pre-set. That is to say, power values are pre-set (e.g. at the time of manufacture). Embodiments are envisaged in which one or more switching programs are pre-defined (e.g. at the time of manufacture) and in use, the user selects from these one or more defined switching programs.

In another aspect herein, the different power on settings are not pre-set but rather may be varied either in response to user input or in response to input from an electronic data management system (e.g. a microprocessor-based system) of the toaster which in turn may receive input from various sensors or measurement devices of the toaster.

Suitably, two power on settings are defined. These generally relate to normal and high power modes of operation. In one preferred embodiment herein, the normal power on setting corresponds to a power of from 700 to 1100 W, particularly 900 W and the high power on setting corresponds to a power of from 1300 to 1700 W, particularly 1500 W.

The at least one toasting element is switchable between the at least two different power on settings during a toasting operation. That is to say, during the course of a toasting operation the power supplied to the at least one toasting element may be switched from one power on setting to another under the control of the electrical power control system.

Preferably, the at least one toasting element is repeatedly switchable between the at least two different power on settings during a toasting operation.

Preferably, the switching between the at least two different power on settings follows a (pre-defined) switching (or pulsing cycle).

In one toasting cycle herein, the toaster is first operated at normal power (e.g. 700 to 1100 W) for a first time period and then at high power (e.g. 1300 to 1700 W) for a second time period, then back to normal power for a time period equivalent to the first time period, then back to high power for a time period equivalent to the second time period, and this switching pattern repeated until the end of the toasting cycle. This toasting cycle is particularly suitable for golden brown toasting of bread with a moist/non-crisp interior.

In another toasting cycle herein, the toaster is first operated at normal power (e.g. 700 to 1100 W) for a first time period and then at low power (e.g. 300 to 700 W) for a second time period, then back to normal power for a time period equivalent to the first time period, then back to high power for a time period equivalent to the second time period, and this switching pattern repeated until the end of the toasting cycle. This toasting cycle is particularly suitable for crisp toasting of bread (with a non-moist interior) in French toast style.

The length of the first and second time period is generally, pre-defined. Suitably, the first time period is from 15 to 25 seconds, particularly 20 seconds and the second time period is from 5 to 15 seconds, particularly 10 seconds. The full toasting cycle is generally from 60 to 120 seconds, particularly from 70 to 100 seconds.

Suitably, the electrical control system additionally comprises an electronic data management system. The electronic data management system has input/output capability and comprises a memory for storage of data; a microprocessor for performing operations on said data; and a transmitter for transmitting a signal relating to the data or the outcome of an operation on the data.

Data may be pre-supplied (e.g. in the form of pre-set power on settings and cycle, switching times). In other aspects, the data may be varied by the user in response to user or sensed or measured inputs for a particular tailored toasting operation.

Suitably, the toaster additionally comprises a data input system for user input of data to the electronic data management system. Preferably, the data input system comprises a man machine interface (MMI) preferably selected from a keypad, voice recognition interface, graphical user interface (GUI) or biometrics interface.

In aspects, the toaster additionally comprises various sensors and/or measurement means for sensing or measuring characteristics of the initial food product, the food product during the toasting operation or of the toaster components in use. Suitable sensors include heat sensors (e.g. infra-red); browning or other colour sensors; reflectance sensors; particle sensors (e.g. for sensing carbon particles which may be related to burning); moisture sensors; and movement sensors.

In one particular aspect, the electronic data management system is arranged to be responsive to or activated by the voice of a user. Thus, for example the system may be switched on or off in response to a voice command.

The electronic data management system may be arranged to be integral with the body of the toaster. Alternatively, the electronic data management system forms part of a base unit which is reversibly associable with the body.

Energy may be conserved by use of a variety of means which enable the electronic data management system to operate on an energy efficient basis. A variety of energy saving methods is available which generally involve reducing power consumption. One such method is to use a clock or timer circuit to switch the power on and off at regular or predetermined intervals. In another method the system can selectively switch on/off specific electronic devices, such as visual display units or sensors, in order to power these devices only when they are required to perform a particular sequence of events. The power sequencing system may also respond to a sensor, such as a motion sensor, which is activated on user interaction with the toaster.

Low power or “micropower” components should be used within the electronics where possible and if a high power device is required for a particular function this should be put into a low power standby mode or switched off when not required.

For low power digital applications complementary metal oxide semi-conductor (CMOS) devices are generally preferred and these may be specially selected by screening for low quiescent currents. Clock speeds of processors and other logic circuits should be reduced to the minimum required for computational throughput as power consumption increases with frequency. Supply voltages should also be kept at minimal values consistent with reliable operation because power dissipation in charging internal capacitance's during switching is proportional to the square of the voltage. Where possible, supply voltages should be approximately the same throughout the circuit to prevent current flowing through input protection circuits. Logic inputs should not be left floating and circuits should be arranged so that power consumption is minimised in the most usual logic output state. Slow logic transitions are undesirable because they can result in relatively large class-A currents flowing. Resistors may be incorporated in the power supply to individual devices in order to minimise current in the event of failure.

Suitably, the toaster additionally comprises a visual display unit for display of data from the electronic data management system to the user. The display may for example, comprise a screen such as an LED or LCD screen. More preferably the visual display unit is associable with the body of the toaster.

Suitably, the toaster additionally comprises a datalink for linking to a local data store to enable communication of data between the local data store and the electronic data management system. The datastore may also comprise data management, data analysis and data communication capability.

The datastore may itself form part of a portable device (e.g. a freestanding device suitable for use in a kitchen) or it may be sized and shaped to be accommodated elsewhere within the patient's home.

The datalink may for example enable linking with a docking station, a personal computer, a network computer system or a set-top box by any suitable method including a hard-wired link, an infra red link or any other suitable wireless communications link.

The toaster may additionally comprise a safety mechanism to prevent unintended multiple actuations thereof. In aspects, the safety mechanism imposes a time delay between successive actuations of the release means. The time delay is typically of the order of from three to thirty seconds.

Suitably, the toaster additionally comprises a release detector for detecting release of toasted product therefrom, wherein said release detector transmits release data to the electronic data management system.

In aspects, the electronic data management system additionally comprises a communicator for wireless communication with a network computer system to enable sending and receipt of data from a network computer system.

In one aspect, the communicator communicates via a gateway to the network computer system. In another aspect, the communicator includes a network server (e.g. a web server) such that it may directly communicate with the network.

In a further aspect, the communicator communicates with the gateway via a second communications device. Preferably, the second communications device is a telecommunications device, more preferably a cellular phone or pager. Preferably, the communicator communicates with the second communications device using spread spectrum radiofrequency signals. A suitable spread spectrum protocol is the Bluetooth (trade mark) standard which employs rapid (e.g. 1600 times a second) hopping between plural frequencies (e.g. 79 different frequencies). The protocol may further employ multiple sending of data bits (e.g. sending in triplicate) to reduce interference.

The electronic data interchange system may comprise any suitable electronic or computer-based system which enables receipt and transmission of information. The electronic data interchange system enables a number of steps, which are initiated and/or authorised by the consumer.

Suitably, the electronic data interchange system forms a hub on a network computer system. The hub may be located on a single server or may be located on multiple servers appropriately linked. The hub is typically located at, and under the control of a network services provider such as a network manager or an Internet Service Provider.

Suitably, the hub is a specific network address in a network computer system. The specific network address may be selected from the group consisting of a web-site address, an e-mail address and a file transfer protocol address. Preferably, the hub is a web-site address on the network computer system.

In one aspect, the network computer system comprises a public access network computer system. The Internet is one suitable example of a public access network computer system, wherein the entrypoint can be any suitable entrypoint thereto including gateways managed by an Internet service provider. The public access network computer system may also form part of a telecommunications system (digital or analogue), which may itself be either a traditional copper wire system, a cellular system or an optical network. The entry point may in embodiment also be via a TV, cable TV, web TV or homeview portal access point.

In another aspect, the network computer system comprises a private access network computer system and the entrypoint is a secure gateway. The private access network system may for example, comprise an intranet or extranet which may for example, be maintained by an information service provider. The secure gateway may for example include password protection; a firewall; and suitable encryption means.

According to another aspect of the present invention there is provided an electric toaster element system for use in a toaster for use in toasting of a food product, said toaster element system comprising

at least one toasting element for toasting said food product; and

an electrical power control system for controlling the power of said at least one toasting element,

wherein said electrical power control system incorporates at least two different power on settings and the at least one toasting element is switchable between said at least two different power on settings during a toasting operation.

The toaster element system is suitable for incorporation into a toaster herein, but may be manufactured and supplied as a separate element (e.g. a sub-assembly) thereof.

According to another aspect of the present invention there is provided a method of toasting of a food product, said method comprising

(a) associating said food product with at least one toasting element;

(b) applying electrical power to said at least one toasting element at a first power on setting for a first time period;

(c) applying electrical power to said at least one toasting element at a second power on setting for a second time period; and

(d) optionally, repeating steps (b) and (c).

Steps (a) to (d) are carried out in sequence to define a toasting cycle.

A preferred method herein comprises

(a) associating said food product with at least one toasting element;

(b) applying electrical power to said at least one toasting element at a first power on setting for a first time period;

(c) applying electrical power to said at least one toasting element at a second power on setting for a second time period;

(d) applying electrical power to said at least one toasting element at said first power on setting for said first time period;

(e) applying electrical power to said at least one toasting element at said second power on setting for said second time period;

and (f) optionally, further repeating steps (d) and (e).

The first and second power on settings are generally pre-set. The term ‘power on’ is used to mean a state where power is supplied to the at least one toasting element and thus excludes the ‘power off’ state where no power is supplied thereto.

The exact values of the different (and generally, pre-set) power on settings may be selected to match the requirements of the particular toasting operation of interest.

Suitably, two power on settings are defined relating to normal and high or low power modes of operation. In one preferred method herein, the normal power on setting corresponds to a power of from 700 to 1100 W, particularly 900 w and the high power on setting corresponds to a power of from 1300 to 1700 W, particularly 1500 W. A low power on setting, in one aspect corresponds to a power of from 300 to 700 W.

In the method herein, the at least one toasting element is switchable between at least two different power on settings during a toasting operation. That is to say, during the course of a toasting operation the power supplied to the at least one toasting element may be switched from one power on setting to another. Such switching is generally achieved through the use of an electrical power control system.

In one toasting method herein, the toasting is first conducted at normal power (e.g. 700 to 1100 W) for a first time period and then at high power (e.g. 1300 to 1700 W) for a second time period, then back to normal power for a time period equivalent to the first time period, then back to high power for a time period equivalent to the second time period, and this switching pattern repeated until the end of the toasting cycle. This toasting method is particularly suitable for golden brown toasting of bread with a moist/non-crisp interior.

In another toasting method herein, the toasting is first conducted at normal power (e.g. 700 to 1100 W) for a first time period and then at low power (e.g. 300 to 700 W) for a second time period, then back to normal power for a time period equivalent to the first time period, then back to high power for a time period equivalent to the second time period, and this switching pattern repeated until the end of the toasting cycle. This toasting cycle is particularly suitable for crisp toasting of bread (with a non-moist interior) in French toast style.

The length of the first and second time period is generally, pre-defined. Suitably, the first time period is from 15 to 25 seconds, particularly 20 seconds and the second time period is from 5 to 15 seconds, particularly 10 seconds. The full toasting cycle is generally from 60 to 120 seconds, particularly from 70 to 100 seconds.

According to a further aspect of the present invention there is provided a computer program product for use with an electric toaster comprising a digital computer comprising software code portions for performing, or requesting user input enabling the performing, of the software implementable steps of the method described above, when said program is run on said digital computer.

Embodiments of the present invention will now be described with reference to the accompanying drawings in which:

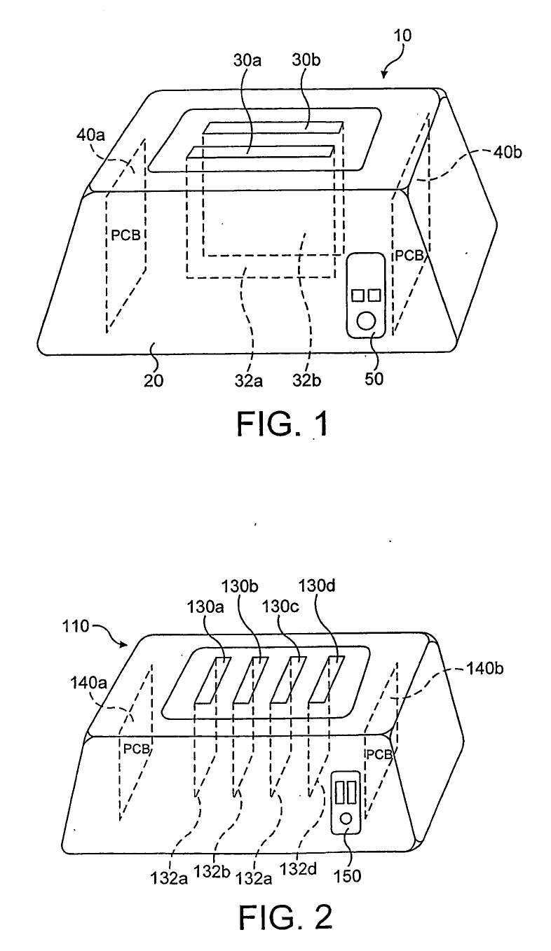

FIG. 1. is a perspective view of a ‘2 bread slice’ electric toaster herein;

FIG. 2. is a perspective view of a ‘4 bread slice’ electric toaster herein;

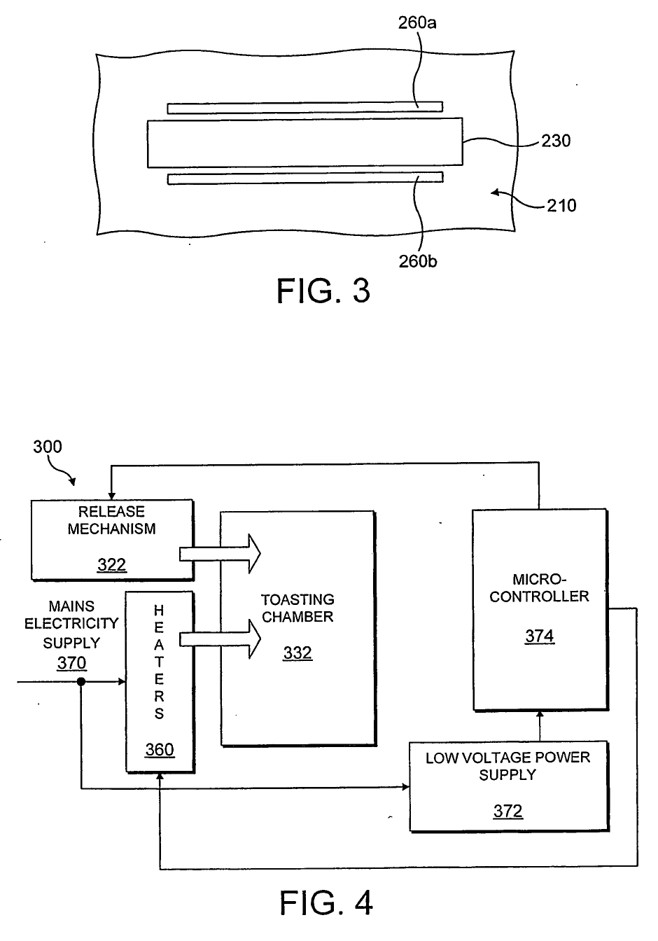

FIG. 3 is a top view of a bread-receiving slot of an electric toaster herein;

FIG. 4 is a system diagram for an electric toaster herein;

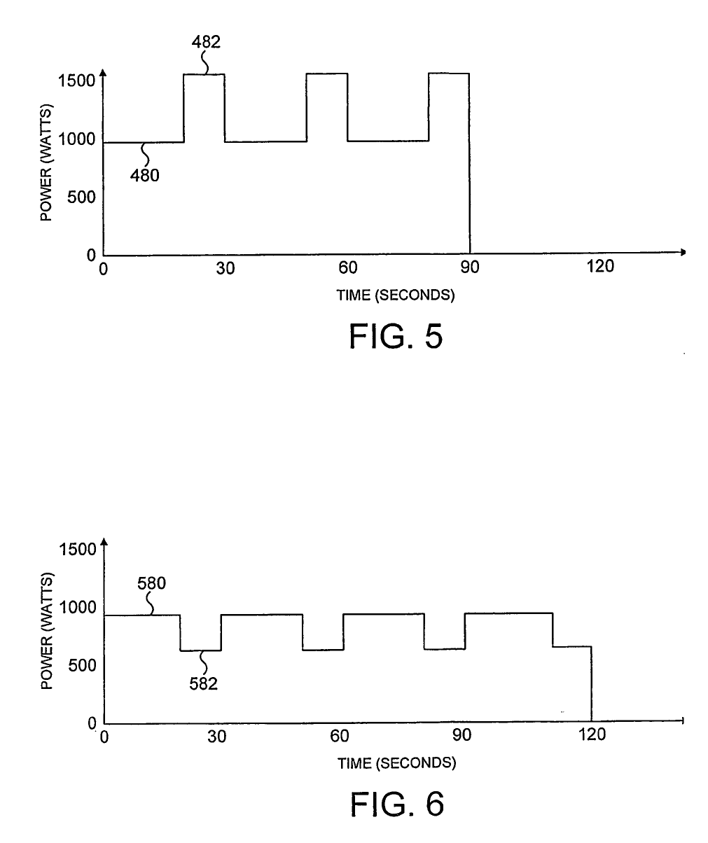

FIG. 5 is a graphical representation of a first power supply cycle herein;

FIG. 6 is a graphical representation of a first power supply cycle herein; and

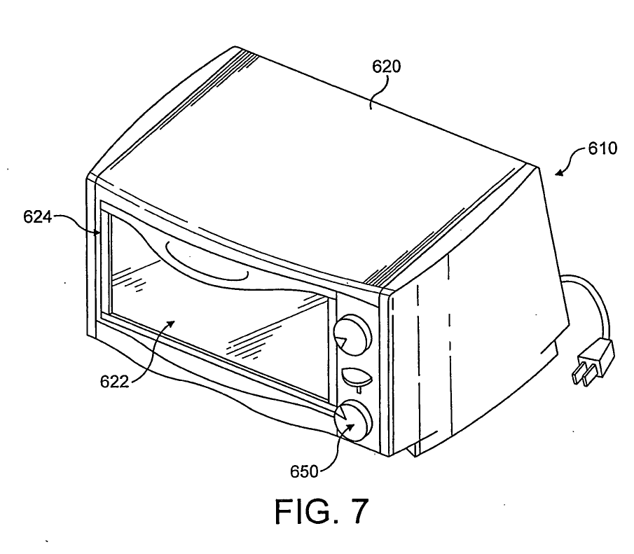

FIG. 7 is a perspective view of an electric toaster oven herein.

FIG. 1 illustrates in perspective view, a first electric toaster herein. The toaster 10 comprises a body 20 which is shaped to sit on a kitchen surface (not shown). The top surface of the body 20 is provided with cavities 32a, 32b accessible by slots 30a, 30b which are sized and shaped to each receive a single slice of bread (not shown). It will be appreciated that in use, a bread slice is fully-received within the cavity 32a, 32b. Heater elements are present in the cavities 32a, 32b (see FIG. 3) and these are powered in response to input from an electric power control system in the form of circuitry carried by printed circuit boards (PCBs) 40a and 40b. The PCBs are in turn, responsive to input from manual control interface 50 which includes various control knobs and switches.

FIG. 2 illustrates in perspective view, a second electric toaster herein which is in essence, a ‘4 slice’ variation of the toaster of FIG. 1. The toaster 110 comprises a body 120 which is shaped to sit on a kitchen surface (not shown). The top surface of the body 120 is provided with four cavities 132a-d accessed by respective slots 130a-d which are sized and shaped to each receive a single slice of bread (not shown). It will be appreciated that in use, the bread slice is fully-received within the cavities 132a-d. Heater elements, present in the cavities 132a-d (see FIG. 3) are powered in response to input from an electric power control system in the form of circuitry carried by printed circuit boards (PCBs) 140a and 140b. The PCBs are in turn, responsive to input from manual control interface 150 which includes various control knobs and switches.

FIG. 3 shows a partial cutaway view of the top part of the body of an electric toaster (e.g. that of FIGS. 1 and 2) looking down on a bread-receiving slot 230 and heater elements 260a, 260b provided to either side of the slot 230. It will be appreciated that the heater elements 260a, 260b extend within the cavity defined by the slot such that in use, toasting heat is provided to a received bread slice. The heater elements 260a, 260b are subject to the control of an electrical power control system (not shown, but see FIG. 4).

FIG. 4 shows a system diagram for an electric toaster power control system herein (e.g. suitable for use with the toaster of FIGS. 1 and 2). The system 300 comprises an input 370 from a mains electricity power supply which electrically powers heaters 360 and a power control unit in the form of a micro-controller 374 which receives power via low voltage power supply 372. The power control unit 370 is associated in a control capability with both the heaters 360 and bread release mechanism 322. The heaters 360 provide toasting heat to toasting chamber 332 within which bread is received for toasting purposes.

In a typical toasting operation herein. A slice of bread is inserted into the slot 30a-b, 130a-d of the toaster such that it. is received with a toasting cavity 32a-b, 132a-d, 232. Power is then supplied to the heater elements 260a-b, 360 which provide toasting heat to the inserted bread. After the toasting operation is complete, the release mechanism 322 pops the bread slice up and partially out of the slot 30a-b, 130a-d and the power to the heaters 260a-b, 360 is switched off.

In accord with the present invention, a particular power supply cycle is employed in which at least two different power on settings are utilised. Whilst many variations are possible, two exemplary power supply cycles are shown in FIGS. 5 and 6 wherein the y-axis shows the amount of power supplied to a heater of the toaster and the x-axis shows time elapsed form the start of a particular toasting cycle.

In the power supply cycle of FIG. 5, the toasting is first conducted at normal power 480 (i.e 900 W) for a first (20 second) time period and then at high power 482 (i.e. 1500 W) for a second (10 second) time period, then back to normal power for 20 seconds and back to high power for 10 seconds and for a further repeat cycle until the end of the toasting cycle (90 seconds) is reached. This toasting method is particularly suitable for golden brown toasting of bread with a moist/non-crisp interior. In aspects, the exact timings and power settings employed may be varied by the user to achieve tailored browning and moisture content of the toasted product.

In the power supply cycle of FIG. 6, the toasting is first conducted at normal power 580 (i.e 900 W) for a first (20 second) time period and then at low power 582 (i.e. 600 W) for a second (10 second) time period, then back to normal power for 20 seconds and back to low power for 10 seconds and for a further two repeat cycles until the end of the toasting cycle (120 seconds) is reached. This toasting cycle is particularly suitable for crisp toasting of bread (with a non-moist interior) in French toast style.

FIG. 7 illustrates in perspective view, an electric toaster oven herein. The toaster oven 610 comprises a body 620 which is shaped to sit on a kitchen surface (not shown). The front part of the body 620 is provided with an access door 622 hinged at hinge axis 624 which enables access to an oven cavity (interior not visible) which is sized and shaped to receive a variety of food products (not shown) for oven toasting. Heater elements (not visble) are provided to the oven cavity and these are powered in response to input from an electric power control system (not visible) in the form of circuitry carried by printed circuit boards (PCBs). The PCBs are in turn, responsive to input from manual control interface 650 which includes various control knobs and switches.

Operation of the toaster oven 610 of FIG. 7 is by any of the toasting methods described herein including those employing the specific power control cycles of FIGS. 5 and 6.

1. An electric toaster for use in the toasting of a food product, said toaster comprising
a body;
within said body, at least one cavity for receipt of said food product;
associated with said at least one cavity, at least one toasting element for toasting the food product; and
an electrical power control system for controlling the power of said at least one toasting element,
wherein said electrical power control system incorporates at least two different power on settings and the at least one toasting element is switchable between said at least two different power on settings during a toasting operation.

2. An electric toaster according to claim 1, wherein the at least one cavity is in the form of a slot shaped to receive a bread slice.

3. An electric toaster according to claim 1, wherein any of the at least two different power on settings is pre-set.

4. An electric toaster according to claim 3, wherein a normal and high power setting are pre-defined.

5. An electric toaster according to claim 4, wherein the normal power setting corresponds to a power of from 700 to 1100 W and the high power setting corresponds to a power of from 1300 to 1700 W.

6. An electric toaster according to claim 3, wherein a normal and low power setting are pre-defined.

7. An electric toaster according to claim 6, wherein the normal power setting corresponds to a power of from 700 to 1100 W and the low power setting corresponds to a power of from 300 to 700 W.

8. An electric toaster according to claim 1, wherein the at least one toasting element is repeatedly switchable between the at least two different power on settings during a toasting operation.

9. An electric toaster according to claim 8, wherein switching between the at least two different power on settings follows a pre-defined cycle.

10. An electric toaster according to claim 9, wherein the pre-defined cycle involves operation at a first power on setting for a first time period and then at a second power on setting for a second time period and subsequent repetitions thereof.

11. An electric toaster according to claim 10, wherein the first time period is from 15 to 25 seconds and the second time period is from 5 to 15 seconds.

12. An electric toaster according to claim 11, wherein the full toasting cycle is from 60 to 120 seconds.

13. An electric toaster according to claim 1, wherein the electrical control system additionally comprises an electronic data management system.

14. An electric toaster according to claim 13, wherein the electronic data management system includes a data input system for user input of data thereto.

15. An electric toaster according to claim 13, additionally comprising a sensor selected from the group consisting of heat sensors; browning sensors; reflectance sensors; particle sensors; moisture sensors; and movement sensors.

16. An electric toaster element system suitable for use in an electric toaster according to claim 1, said toaster element system comprising
at least one toasting element for toasting said food product; and
an electrical power control system for controlling the power of said at least one toasting element,
wherein said electrical power control system incorporates at least two different power on settings and the at least one toasting element is switchable between said at least two different power on settings during a toasting operation.

17. A method of toasting of a food product, said method comprising
(a) associating said food product with at least one toasting element;
(b) applying electrical power to said at least one toasting element at a first power on setting for a first time period;
(c) applying electrical power to said at least one toasting element at a second power on setting for a second time period; and
(d) optionally, repeating steps (b) and (c).

18. A method according to claim 17, wherein steps (b) and (c) are repeated at least once.

19. A method according to claim 17, wherein the first and second power on settings are pre-set.

20. A method according to claim 17, wherein the first power on setting corresponds to a power of from 700 to 1100 W and the second power on setting corresponds to a power of from 1300 to 1700 W.

21. A method according to claim 17, wherein the first power on setting corresponds to a power of from 700 to 1100 W and the second power on setting corresponds to a power of from 300 to 700 W.

22. A method according to claim 17, wherein the length of the first and second time periods is pre-defined.

23. A method according to claim 22, wherein the first time period is from 15 to 25 seconds and the second time period is from 5 to 15 seconds.

24. A method according to claim 23, wherein the full toasting cycle is from 60 to 120 seconds.

25. A computer program product for use with an electric toaster comprising a digital computer comprising software code portions for performing, or requesting user input enabling the performing, of the software implementable steps of a method according to claim 17, when said program is run on said digital computer.
